(19) United States
(12) Patent Application Publication
(10) Pub. No.: US 2005/0150674 A1
(43) Pub. Date: Jul. 14, 2005

(54) Waterproof system between header and junction box

(75) Inventor: Luis Miguel Munoz, Reus Tarragona (ES)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 11/002,925

(22) Filed: Dec. 2, 2004

(30) Foreign Application Priority Data
Dec. 5, 2003 (DE) 203 18 863.2

(51) Int. Cl. H01H 9/02

(52) U.S. Cl. 174/53

(57) ABSTRACT

A holding and connecting device (1) for an electrical circuit (2), particularly in the form of a printed board assembly, with at least one terminal box (4) for producing an electrical connection to the electrical circuit. The holding and connecting device (1) has at least one insertion opening (5) with a circumferential opening edge (6) that has a sealed contact with an assigned, essentially circumferential edge flange (7) of the terminal box (4).

The invention refers to a holding and connecting device for an electrical circuit, particularly a printed board assembly, with at least one terminal box for producing an electrical connection to the electrical circuit.

Such holding and connecting devices are used, for example, in vehicles, in order to cover and/or hold corresponding electrical circuits. Contacting of the circuit and connection to a vehicle device that is to be controlled, such as a headlight, windshield wiper, heater, injection system, or the like, takes places through the terminal box using a corresponding electrical line.

As a rule, the corresponding electrical circuits and assigned holding and connecting devices are arranged inside the motor vehicle in such positions in which at least moisture in the form of condensation or splashed water can arise.

For example, in order to protect the terminal box and contacts of the corresponding lines from such moisture, a labyrinth-type seal between a lid and a housing of the terminal box is proposed in U.S. Pat. No. 4,654,470. This should prevent the moisture from penetrating into the terminal box.

An additional possibility for sealing the lid and housing of a terminal box is disclosed in US-A-5703325. Both of the cited publications are lacking reference to the type of terminal box connection, however, and its integration with or into a holding and connecting device for a corresponding electrical circuit.

The object of the present invention is to improve a corresponding holding and connecting device of the type mentioned at the beginning, to the effect that a corresponding terminal box is integrated into this device in such a way that the design is simple and there is a seal against moisture.

This object is solved by means of the features of claim 1.

According to the invention, separately laid electrical connection cables or the like between the terminal box and the holding and connecting device can be dispensed with. Such a connection cable would have to be fed in a sealed way into both the terminal box and the holding and connecting device. Furthermore, a connection between the terminal box and the motor vehicle device to be controlled would correspondingly have to be led out of the terminal box, again in a sealed manner. According to the invention, instead at least one insertion opening is provided directly in the holding and connecting device, through which the contacting of the electrical circuit from the side of the terminal box takes place. In this regard, the corresponding insertion opening is formed by the terminal box itself or by the sealing contact between the circumferential opening edge of the insertion opening and the assigned, likewise essentially circumferential edge flange of the terminal box. In this way, no separate sealing measures are necessary for the electrical connection on the terminal box and also on the holding and connecting device. The connection between the terminal box and the motor vehicle device to be controlled can be made in the customary way.

Furthermore, by arranging the terminal box in the area of the corresponding insertion opening, the result is a direct assignment of the terminal box and the holding and connecting device, which can, for example, also be marked with appropriate imprints. This eliminates errors when the terminal box is connected to the corresponding motor vehicle device. Furthermore, the cabling effort is considerably reduced with the invention, because corresponding connections between the holding and connecting device of the electrical circuit and the terminal boxes are considerably shortened, and can already be made during the assembly of the holding and connecting device and the electrical circuit. In this way, the degree of prefabrication of the corresponding components is increased in accordance with the invention.

An additional advantage in accordance with the invention is that the installation of the holding and connecting device with assigned electrical circuit is likewise simplified by the arrangement of the terminal box(es) directly at the holding and connecting device, or its/their integration into this device. The corresponding terminal boxes which are attached at appropriate locations in the vehicle, do not have to be separately removed in case of a repair. Instead, only the corresponding cable connection between the terminal box and the motor vehicle device has to be removed, and then the entire holding and connecting device can be removed with the terminal box(es).

Furthermore, it must be observed that not only the cabling effort is reduced according to the invention, but, because of this reduction, the susceptibility to faults of the corresponding devices is also reduced, because the connections between the electrical circuit and terminal box can already be made and tested before being installed in the vehicle, and within the vehicle, these connections are not subjected to any special demands that could possibly lead to damage.

Costly measures for sealing the terminal box or the electrical circuit of the holding and connecting device are not necessary according to the invention, because the sealing is accomplished directly by the contact of the opening edge and the edge flange.

There are different possibilities for forming the terminal box as a part of the holding and connecting device or for connecting these parts. For example, the opening edge and edge flange could be connected to each other. Such a connection can be made by gluing or heat-sealing, whereby the holding and connecting device and the terminal box are made of plastic, as a rule. In order to provide a releasable connection, however, these different parts can also be screwed together.

The manufacture and assembly of the holding and connecting device with terminal box according to the invention can be simplified by means of having the terminal box inserted in the insertion opening with its insertion end and having it protrude from a holder of the holding and connecting device with its opposite connection end. By means of this insertion of the insertion end, there is precise assignment of the terminal box to the corresponding insertion opening and the production of the corresponding electrical connection is simplified by this precise matching. Furthermore, a connection can be made between the terminal box and the holder in the area of the insertion opening and the inserted insertion end.

The sealing between the edge flange and the opening edge can be made in this connection, for example, by having the edge flange lie on the opening edge from above, which simultaneously determines the insertion depth of the insertion end. In this way, the terminal box would be inserted into the insertion opening from the side facing away from the electrical circuit during the assembly of the terminal box.

A simple holder can be seen in one that has an essentially smooth cover in which the at least one insertion opening is arranged, whereby components of the electrical circuit are held and/or contacted on an interior side of the cover. The terminal box can also be connected with the corresponding contacts or components via the insertion opening.

According to the invention, there is likewise the possibility that the terminal box is mounted from the interior side of the holder or cover, which faces the electrical circuit. In this connection, it is advantageous if, when in the mounted position of the terminal box, the edge flange grabs behind the opening edge, whereby the edge flange is in a sealed contact with the opening edge on the interior side of the holder.

In order to be able to improve the sealing between the edge flange and the opening edge further, the edge flange can be formed as an essentially U-shaped groove in whose U-shaped opening the opening edge engages. On the one hand, the groove can serve to hold certain moisture that collects in the groove and that is later released to the outside, for example, by means of evaporation. On the other hand, the sealing effect is improved by the engagement of the opening edge in the U-shaped opening, because essentially a labyrinth-type seal is formed.

A simple embodiment can be seen in having the opening edge be formed as an edge leg that essentially sticks out perpendicularly from the interior side. In this connection, the corresponding sealing effect can be realized by having the edge leg lie flat within the U-shaped groove on one side or also by having it held on both sides by the groove in a sealing fashion.

There is likewise or also additionally the possibility that the edge leg has a sealing contact with the groove bottom.

A further alternative for sealing can be realized by having the length of the edge leg be smaller than the depth of the groove, and the interior side of the cover lie on the free end of an outer U-shaped leg of the groove, forming a seal. This can be formed within the groove, either as an alternative to or supplementary to a one-sided or also two-sided sealing contact of the edge leg within the groove.

In order to prevent moisture drops from running into the groove along the holder, depending on the assembly of the holding and connecting device, a counter leg can stand out from the exterior side of the cover opposite from the edge leg. This counter leg serves as a collector for correspondingly draining moisture drops, and it prevents them from penetrating into the groove.

A guide aid during assembly of the terminal box into the corresponding insertion opening can be seen in having the edge leg and/or counter leg extend parallel to a wall of the terminal box. In this connection, there is likewise the possibility that the edge leg and I or counter leg is/are in direct contact with the wall, and that, in this way, it/they form(s) an additional sealing measure.

In order to simplify the insertion of the terminal box into the insertion opening, the edge leg and/or counter leg can run at a distance to a wall of the terminal box. In this way, there is sufficient guidance when the terminal box is inserted, so that even automatic assembly is easily possible, while, at the same time, guidance of the terminal box that would be too narrow and that could possibly lead to jamming or the like is prevented.

In principle, there is the possibility of further improving the sealing between the corresponding parts of the terminal box and cover or holder by using additional sealing materials. According to the invention, however, such additional sealing materials are not necessary, so that the sealing between the terminal box and the holder can be accomplished without sealing materials.

In order to enable corresponding contacts in the terminal box for electrical connections to devices within the vehicle in a simple way, a bottom wall of the terminal box can have a multiple number of openings for feeding through electrical lines or the like. These electrical lines can be mounted inside the terminal box on a plug or the like. There is likewise the possibility of having the corresponding electrical lines formed directly by contact fingers or the like of the corresponding components of the electrical circuit.

In order to arrange the terminal box particularly with its bottom wall at a particular distance to the electrical circuit or printed board assembly, the bottom wall can have a number of spacing elements on its bottom side, which faces the electrical circuit. These can stand directly on the electrical circuit or, in case of external compression stress on the holder, can prevent the holder or cover from being pressed on to the electrical circuit.

In principle, there is a possibility in this connection that the corresponding exterior U-shaped leg extends just as far in the direction of the electrical circuit as the spacing elements, or itself functions as a spacing element, so that separate spacing elements are no longer necessary. According to the invention, there is likewise the possibility that the length of the spacing elements is larger than the length of the outer U-shaped leg of the groove, so that, if applicable, only the spacing elements are in contact with the electrical circuit, while the groove and U-shaped leg cannot end up in contact with the electrical circuit.

In order to be able to produce a connection within the terminal box to electrical lines to additional devices within the vehicle in a simple fashion, the terminal box can have a corresponding opening on its connection end that protrudes from the holder. In order to prevent moisture from penetrating in the area of this opening, however, this opening can be made tightly sealable with a lid.

In the following, advantageous embodiments of the invention are explained in more detail using the figures included with the drawing.

Shown are:

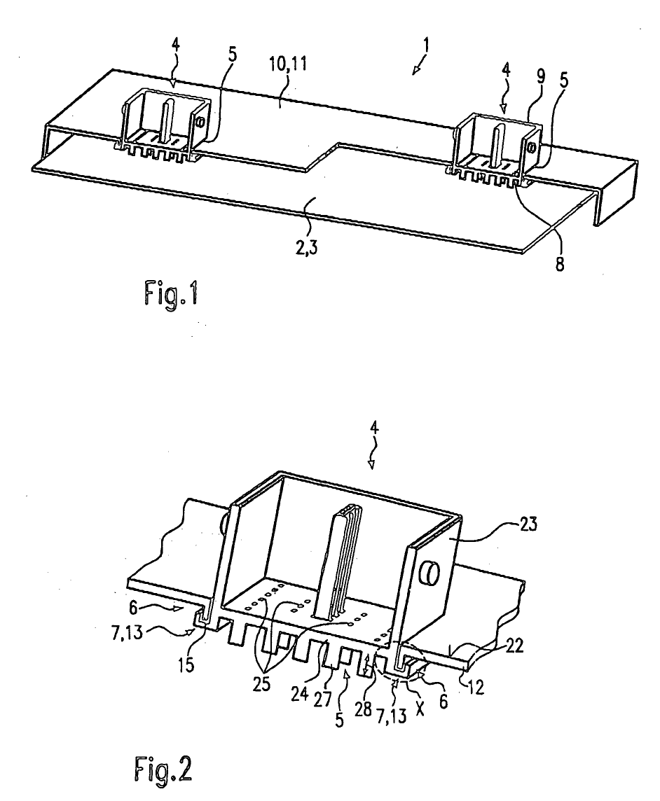

FIG. 1 a partial depiction, in perspective, of a holding and connecting device according to the invention, with some parts cut away;

FIG. 2 an enlarged representation of the holding and connecting device according to FIG. 1 in the area of a terminal box;

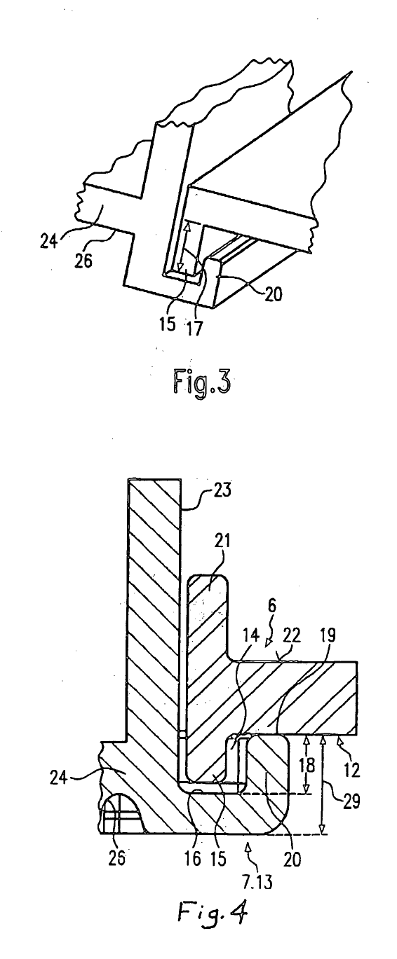

FIG. 3 an enlarged representation of the detail “X” from FIG. 2 for a first embodiment, and

FIG. 4 a second embodiment for the detail “X”.

FIG. 1 shows a diagonal perspective top view of a partially cut away embodiment of a holding and connecting device 1 according to the invention. This serves both to hold an electrical circuit 2 particularly in the form of a printed board assembly 3 with components and to contact the printed circuit board or corresponding components. The holding and connecting device 1 comprises a holder 10 in the form of a cover 11, which is essentially shell-shaped, and which holds the electrical circuit 2. The insertion openings 5 are arranged in the cover 11. Terminal boxes 4 are inserted into these openings with their insertion end 8. A connection end 9, opposite the corresponding insertion end 8, of each terminal box 4 protrudes from the cover 11. I n order to simplify, corresponding lids or covers of the open connection end 9 are not shown in FIG. 1. Such lids or covers are in tight contact with the corresponding terminal box 4. Also not depicted are additional connection lines or other electrical connections from the corresponding terminal boxes 4 to pieces of equipment, particularly of a motor vehicle, such as an injector, windshield wiper, heater, air conditioner, headlight or the like, that are operated and controlled by the electrical circuit 2.

FIG. 2 shows a terminal box 4 from FIG. 1 in enlarged format. This has a wall 23 that is essentially rectangular in cross-section. At the lower end of the wall, i.e., at the insertion end 8 of the terminal box 4, an edge flange 7 is arranged. This is formed as a U-shaped groove 13. The edge flange 7 is in a sealing contact with an opening edge 6 that edges the corresponding insertion opening 5. The opening edge 6 in the embodiment according to FIG. 2 has an edge leg 15 that essentially sticks out perpendicularly from an interior side 12 of the cover 11, see also FIGS. 3 and 4. This edge leg 15 is inserted from above through a corresponding U-shaped opening 14 of the groove 13 into this groove 13.

The terminal box 4 has a bottom wall 24 on its insertion end 8, in which a multiple number of openings 25 are arranged for feeding through electrical connection lines or the like. On a bottom side 26 of the bottom wall 24, a number of spacing elements 27 protrude in the direction of the electrical circuit 2, see also FIG. 1. A length 28 of these spacing elements 27 can be dimensioned such that the spacing elements protrude just to a surface of the electrical circuit 2. The length 28 of the spacing elements 27 is shorter than a corresponding length 29, see FIG. 4, of a U-leg 20, lying on the outside of the groove 13.

In one embodiment of the invention, the openings 25 can be fed through the spacing elements 27, so that the corresponding electrical connections are fed through the spacing elements 27 all the way into the interior of the terminal boxes 4.

FIGS. 3 and 4 show two different embodiments for the sealing between the opening edge 6 and edge flange 7, whereby these views correspond to the detail “X” from FIG. 2.

In the embodiment according to FIG. 3, the edge leg 15 has a length 17 that is larger than a corresponding depth 18, see FIG. 4, of the groove 13. In this way, a free end of the edge leg 15 is in a sealing contact with the groove bottom 16. Edge leg 15 and U-shaped leg 20 run essentially parallel to each other and likewise parallel to the wall 23 of the terminal box 4.

In the further embodiment according to FIG. 4, the corresponding length 17 of the edge leg 15 is less than the groove depth 18. This results in a free end 19 of the U-shaped leg 20 having a sealing contact with the interior side 12 of the cover 11. There is a distance formed between the free end of the edge leg 15 and the groove bottom 16.

In both embodiments according to FIGS. 3 and 4, the corresponding edge leg 15 is inserted from the top into the corresponding U-shaped opening 14 of the groove 13. In this way, the U-shaped leg 20 grabs behind the corresponding edge leg 15.

Opposite the edge leg 15, a counter leg 21 sticks out from an exterior side 22 of the cover 11. This runs in extension and parallel to the edge leg 15 and likewise to the wall 23, whereby both legs are arranged at a distance from the wall 23. The counter leg 21 prevents fluid drops from running into the groove 13 along the exterior side 22 of the cover 11, depending on the installation position of the holding and connecting device 1. Edge leg 15 or interior side 12 of the cover 11 and groove 13 prevent moisture from penetrating into the holding and connecting device 1.

Consequently, according to the invention, the result is a holding and connecting device with essentially integrated terminal boxes 4, which are inserted into corresponding inserting openings 5 of a cover 11 of the holding and connecting device 1 at least partially and in a way that is sealed against fluids. The corresponding fluid sealing is achieved by means of a sealing contact of the edge flange 7 and opening edge 6, see FIGS. 3 and 4.

1. Holding and connecting device (1) for an electrical circuit (2), particularly in the form of a printed board assembly, with at least one terminal box (4) for producing an electrical connection to the electrical circuit,
characterised in that
the holding and connecting device (1) has at least one insertion opening (5) with a circumferential opening edge (6) that has a sealed contact with an assigned, essentially circumferential edge flange (7) of the terminal box (4).

2. Holding and connecting device according to claim 1,
characterised in that
the terminal box (4) is inserted with its insertion end (8) in the insertion opening (5) and that its opposite connection end (9) protrudes from a holder (10) of the holding and connecting device (1).

3. Holding and connecting device according to claim 1,
characterised in that
the holder (10) has an essentially smooth cover (11) in which the at least one insertion opening (5) is arranged, whereby components of the electrical circuit (2) are held and/or contacted on an interior side (12) of the cover (11).

4. Holding and connecting device according to claim 1,
characterised in that
the edge flange (7) grabs behind the opening edge (6).

5. Holding and connecting device according to claim 1,
characterised in that
the edge flange (7) is formed essentially as a U-shaped groove (13) in whose U-shaped opening (14) the opening edge (6) engages.

6. Holding and connecting device according to claim 1,
characterised in that
the opening edge (6) is formed as an edge leg (15) that essentially sticks out perpendicularly from the interior side (12).

7. Holding and connecting device according to claim 1,
characterised in that
the edge leg (15) makes a sealing contact with the groove bottom (16) of the groove (13).

8. Holding and connecting device according to claim 1,
characterised in that
the length (17) of the edge leg (15) is smaller than the depth (18) of the groove (13) and the interior side (12) of the cover (11) lies on the free end (19) of the outer U-shaped leg (20) of the groove (13) such that a seal is formed.

9. Holding and connecting device according to claim 1,
characterised in that
a counter leg (21) opposite the edge leg (15) sticks out from the exterior side (12) of the cover (11).

10. Holding and connecting device according to claim 1,
characterised in that
the edge leg (15) and/or the counter leg (21) extend parallel to a wall (23) of the terminal box (4).

11. Holding and connecting device according to claim 1,
characterised in that
the edge leg and/or counter leg (15, 21) run at a distance frm the wall (23) of the terminal box (4).

12. Holding and connecting device according to claim 1,
characterised in that
the seal between the terminal box (4) and holder (10) is free of sealing material.

13. Holding and connecting device according to claim 1,
characterised in that
a bottom wall (24) of the terminal box (4) has a multiple number of openings (25) for feeding through electrical lines or the like.

14. Holding and connecting device according to claim 1,
characterised in that
the bottom wall (24) has a number of spacing elements (27) on its bottom side (26), which is facing the electrical circuit (2).

15. Holding and connecting device according to claim 1,
characterised in that
the length (28) of the spacing elements (27) is larger than the length (29) of the outer U-shaped leg (20) of the groove (13).

16. Holding and connecting device according to claim 1,
characterised in that
the terminal box (4) can be tightly closed with a lid on the connection end (9) that protrudes from the holder (10).
